(19) United States
(12) Patent Application Publication
(10) Pub. No.: US 2001/0020229 A1
(43) Pub. Date: Sep. 6, 2001

(54) METHOD AND APPARATUS FOR DETERMINING HIGH SERVICE UTILIZATION PATIENTS

(76) Inventor: ARNOLD LASH, BRANCHBURG, NJ (US)

Correspondence Address: DONALD W WYATT, SCHERING-PLOUGH CORPORATION, PATENT DEPARTMEN K-6-1990, 2000 GALLOPING HILL ROAD, KENILWORTH, NJ, 070330530

(21) Appl. No.: 09/126,167

(22) Filed: Jul. 30, 1998

Related U.S. Application Data
(60) Provisional application No. 60/054,384, filed on Jul. 31, 1997.
(60) Provisional application No. 60/082,172, filed on Apr. 16, 1998.

(51) Int. Cl. G06F 17/60

(52) U.S. Cl. 705/3

(57) ABSTRACT

An automated method and system for predicting the likelihood that a patient will acquire high medical service utilization characteristics, thereby becoming a high-cost patient to a managed care organization or the like, relative to other patients includes selecting a predictive subset of variables from a larger set of variables corresponding to patient claims data based on the results of multivariate statistical modeling, such as logistical regression analysis. Predetermined weighing coefficients derived from the statistical modeling are applied to each of the claims variables of the predictive subset and a probability equation is developed based upon the weighing coefficients and claims variables of the predictive set. The probability equation is applied to patient claims data to determine a probability value indicative of the likelihood that the given patient will have a high utilization of health care resources in a given period of time, and thereby become a higher-cost patient relative to other patients. Once identified, high-use patients can be targeted for preventative medical interventions.

This application claims the benefit of U.S. provisional applications No. 60/054,384 filed Jul. 31, 1997 and No. 60/082,172 filed Apr. 16, 1998.

### FIELD OF THE INVENTION

The present invention relates to disease management and, more particularly, to a method and system for determining, based on patient claims data, the likelihood that a patient will become or remain a high user of health care services relative to others, e.g., as a patient in a managed care organization or the like.

### BACKGROUND OF THE INVENTION

As health care costs continue to rise, the need to develop new ways of lowering such costs is manifest. With rising cost, managed care organizations such as HMOs, PPOs, etc. (collectively “MCOs”) have become more popular in recent years since they are often effective in providing lower-cost health care to their members through the use of cost-containment programs and techniques. However, MCOs and other organizations who manage the health care of populations continue to look for new ways to improve their efficiency and to reduce health care costs for themselves and for their participants. For instance, one way MCOs are now attempting to reduce costs is to try to target those patients who utilize more high-cost health care resources than other members of the MCO and attempt to improve the health of such individuals so as to lower utilization costs.

In one approach, MCOs have begun to implement disease management programs in an effort to lower the high health care costs associated with certain groups of patients; namely, those patients having chronic or long-term diseases. Disease management programs typically focus on improving the health of patients suffering from chronic illness or disease in order to reduce the frequency of the occurrence of future high-cost medical episodes for the patient, such as hospital emergency room (“ER”) visits and hospital stays. To the MCO, the financial savings achieved by lowering frequency of health care utilization for patients with chronic diseases through effective disease management can then be passed on as lower costs for all patients of the MCO.

One way a MCO can target patients for preventative care is to look only for those patients in the MCO who, during the past year, utilized the medical services more frequently than others, particularly high cost services, based on the assumption that such patients are likely to be high users of services in the next year. However, it is not always the case that a high service use patient during one year will be a high use patient during the next year. In fact, in some situations, high use patients in the past year will actually become low use patients in the next year. Thus, merely determining who was a high user of services in the past is not an entirely reliable methodology for targeting these high-use patients, and this method can result in wasted cost and efforts. Therefore, predicting with accuracy which patients will be high users of medical services relative to other patients in the future is quite valuable to an MCO, since it allows the MCO to target the proper populations of patients who will likely be high service user patients so that preventative or other medical care can be directed to them in order to reduce the risk that they will actually become high users of medical services.

Clearly, the ability to accurately predict which patients may become or remain high-use patients is beneficial to an MCO in the attempt to reduce health care costs and make efficient and effective use of its resources by targeting the proper group of patients. By lowering the costs associated with potential high-use patients, particularly where the service they use if costly, all patients of the MCO or other health care organization can benefit and insurance costs can be lowered. Therefore, there is a great need to develop a system which can accurately predict those patients who are most likely to incur future clinical complications and the high utilization of services and costs associated with those events.

### SUMMARY OF THE INVENTION

The present invention provides an automated data processing system for predicting the likelihood that a patient will acquire high service utilization characteristics, thereby becoming more of a high-cost patient to a managed care organization or the like, than other patients. The system includes a computer comprising input and output devices, a stored program executable by the computer, and memory means for storing input data. The input data comprises a predetermined subset of claims data taken from a larger set of patient claims data. The claims data are organized by categories corresponding to potential claims variables. The subset of the claims data is selected based on the results of multivariate statistical regression modeling which selects high relevance claims variables from the potential claims variables to predict whether a patient will acquire high-use characteristics. The stored program analyzes the subset of claims data according to a probability equation created by the regression analysis, which equation is based at least in part on the sum of each of the high relevance claims variables multiplied by corresponding weighing coefficients. The stored program computes probability values for each patient which are indicative of the likelihood that the patient will acquire high service utilization characteristics. For instance, such high service use characteristics can include the patient suffering one or more high-cost medical events or episodes, or the patient becoming a high user of services overall relative to other patients.

Preferably, the statistical modeling used is logistic regression analysis and the probability equation is computed according to the equation:

P=e^{logit}/(1+e^{logit})

where P is the probability that a given patient will become a high-use patient, e is a constant which is the base of natural logarithms, and logit is the sum of (i) a predetermined constant and (ii) each of the high relevance claims variables multiplied by its respective coefficient. The coefficients are preferably logistic regression coefficients.

The present invention is desirably used to predict which patients of various types, e.g., asthmatic or diabetic patients, will become heavy users of medical services. In such a case, the high relevance claims variables may comprise variables representing, for instance, the number of emergency room (“ER”) visits by the patient in the past year, whether the patient has been diagnosed in the past as having a certain symptom of a disease or condition (e.g., allergies) and whether the patient has suffered any related complications in the past year.

In addition to apparatus, the present invention also provides a method of operating such apparatus for predicting the likelihood that a patient will acquire high service utilization characteristics. According to this method, a predictive model for predicting the likelihood that a patient will acquire high-use characteristics is developed by (i) selecting an initial set of potentially predictive patient claims variables suspected to have a potential effect on an outcome variable, the outcome variable corresponding to a high-use criterion during a targeted future time; (ii) conducting multivariate statistical regression modeling on the potentially predictive variables; (iii) evaluating the results of the analysis and eliminating the least predictive of the potentially predictive variables from the model; (iv) continuing the multivariate statistical regression modeling analysis and eliminating the next least predictive of the potentially predictive variables from the model; (v) repeating steps (ii) through (iv) until each of the remaining claims variables have a value greater that a predetermined threshold significance value; and (vi) basing the model on the remaining claims variables. Once the model is created, in the form of a probability equation, the variables for patients are input to the data processing system and analyzed according to the probability equation in the computer. This equation is based at least in part on the sum of each relevant claims variables multiplied by corresponding weighing coefficients for each. As a result, the stored program computes the probability values for each patient indicative of the likelihood that the patient will acquire high-use characteristics.

Preferably, the statistical modeling comprises logistic regression modeling. More preferably, the method includes the step of verifying the accuracy of the model by applying calibration and discrimination testing. Further, the method also preferably comprises the steps of setting a threshold probability value and targeting those patients falling above the threshold probability value for preventative medical interventions.

### BRIEF DESCRIPTION OF THE DRAWINGS

The foregoing and other features of the present invention will become more readily apparent from the following Detailed Description of Preferred Embodiments taken in conjunction with the appended drawings, in which:

FIG. 1 depicts a representation of a patient claims database;

FIG. 2 is a block diagram of a computer system used in connection with the present invention;

FIG. 3 is a flow chart of the operation of the computer system of FIG. 2 to both create a model of the likelihood a patient will be heavy user of medical services and to score individual patient data with the model to identify individual patients who are likely to become high-use patients;

FIG. 3A is a flow chart of a program for a computer system to score individual patients on the basis of models created earlier on other computer systems;

FIG. 3B is a flow chart of a program for creating models predictive of whether a patient will be a high user of services;

FIG. 4 is a flow chart showing the development of various interventions created for patients likely to become high users; and,

FIG. 5 is a chart illustrating how various factors can be used to determine the disease or condition of a patient without a diagnosis.

### DETAILED DESCRIPTION OF PREFERRED EMBODIMENTS

The present invention presents a system including a computer apparatus and a method of operating the computer apparatus for predicting the likelihood that a patient will become or remain a high user of medical services, e.g., as a patient in a managed care organization (MCO) or the like, relative to other patients of the MCO. Of course, it should be appreciated that the present invention can be used by any organization or entity which manages the health care of others, such as employers who manage their employee health care plans, for use in targeting high service use patients. Further, the system of the present inventions tracks variables related to the use of medical services. While it is clear that higher than normal use of the services provided may translate to increased costs, it should also be understood that even infrequent use of high cost services (e.g., emergency room visits) may be determined according to the present invention.

The predictive modeling system of the present invention, unlike predictive models based on single patient variables (such as patient cost from a prior year), makes use of rigorous, multivariate statistical modeling to develop multiple-variable predictive models for determining the likelihood of a particular member of a health care plan will acquire high use characteristics, particularly those with attendant high costs, such as suffering frequent high-cost medical episodes or utilizing health care resources in such a way so as to become a high-cost patient overall relative to other patients. The present invention evaluates both the presence and absence of certain events as a measure of a patient's future risk utilizing statistical tools.

As shown in FIG. 1, a representative patient claims database 10 is provided. Database 10 contains information about each member patient in a MCO or other organization, including insurance claims data and medical encounter data for a given period of time. Such data preferably includes information representing the patient's prior utilization of medical and pharmacy services, and may also include the cost of these services. For example, the claims data may include, on a yearly basis, information such as the number of hospital in-patient days for a particular illness, the total number of hospital in-patient days, the number of ER visits, the number of prescriptions filled, the presence of a specific disease or condition related diagnosis, etc.

Database 10 can store information for multiple time periods, such as by month, quarter, year, etc. In FIG. 1, however, only one period of time is shown in database 10 for illustrative purposes. Database 10 includes, in the first column a list of patients represented by the numbers 1 through n, with n representing the total number of patients stored in the database. Database 10 also includes, in the first row, a list of claims variables represented by the letters A through Z. Any number of claims variables can be used depending on what claims information is tracked by the MCO. Data corresponding to each patient's claims, represented by “xx,” is stored in the individual cells in the row corresponding to each patient. For instance, column A may represent the claims information on the number of ER visits in the subject year. For example, for patient 1, with the claims variable A representing ER visits, the data stored in cell 12 (i.e., column A, row 2) might be the number 4, representing the fact that patient 1 had 4 ER visits in the given year. Database 10 is stored in a computer readable format such as on a hard disk, CD-ROM or other electromagnetic or optical storage medium, such that it can be updated, read and managed by a database program. FIG. 1 is illustrative of the logical arrangement of the data, but does not necessarily represent the physical arrangement. A database program run on a mainframe computer may be used for constructing and the maintaining database. Alternatively, a database constructed by a software database or spreadsheet program running on a PC, such as Microsoft ACCESS or EXCEL, can be used.

Out of all the possible claims data, only a given selection of data, such as selection 20, is taken and used as data corresponding to claims variables (here variables B, C and D) used in the predictive model of the present invention. The particular selection of these claims variables, the so-called “high relevance” claims variables, is determined in accordance with multivariate statistical modeling methods and analysis described below. The predictive model, in addition to including preselected, high relevance claims variables, also includes predetermined coefficients for each selected variable. The coefficients are determined by the regression analysis on the relative importance of the variable in predicting the model outcome. The coefficients are multiplied by their corresponding variable to account for the importance or weight of that variable in the overall probability equation.

The probability equation is constructed using the high relevance claims variables and their respective coefficients. The equation is then used in conjunction with the patient claims database in order to arrive at a probability value for each patient which is indicative of the likelihood that the patient will utilize more services than is typical for most patients, perhaps because the patient has suffered one or more significant medical events, and as a result has become or remains a high-use patient overall to the MCO. In other words, the equation predicts the likelihood that the patient win be a high utilizer of medical resources in a given period of time relative to other patients.

Preferably, the statistical methodology used is multivariate logistic regression analysis modeling, although other types of regression analysis may be used, such as linear regression analysis. In general, as is well-known by those skilled in the statistics art, regression modeling or analysis can be used to derive an equation that relates one dependent criterion variable to one or more predictor variables. Regression analysis typically considers the frequency distribution of the criterion variable when one or more predictor variables are held fixed at various levels. For instance, linear regression uses a regression model in which the response variable (Y) is linearly related to each explanatory variable. Simple linear regression is the case where there is only a single explanatory variable (X). Logistic regression utilizes a regression model for binary (dichotomous) outcomes, and the data are assumed to follow binomial distributions with probabilities that depend on the independent variables.

Logistic regression analysis modeling utilizes the formula.

P=e^{logit}/(1+e^{logit})

where e is a mathematical constant equal to the base of the natural logarithm. The “logit” is computed from the sum of the products of each coefficient and respective variable. In other words, for n variables (v) used in the predictive model, the logit is computed as follows:

logit=(c₁*vᵢ)+(c₂*v₂)+(c₃*v₃)+ . . . +(cₙ*vₙ)+constant

where c₁ is the coefficient corresponding to variable v₁, c₂ is the coefficient corresponding to variable v₂, etc.

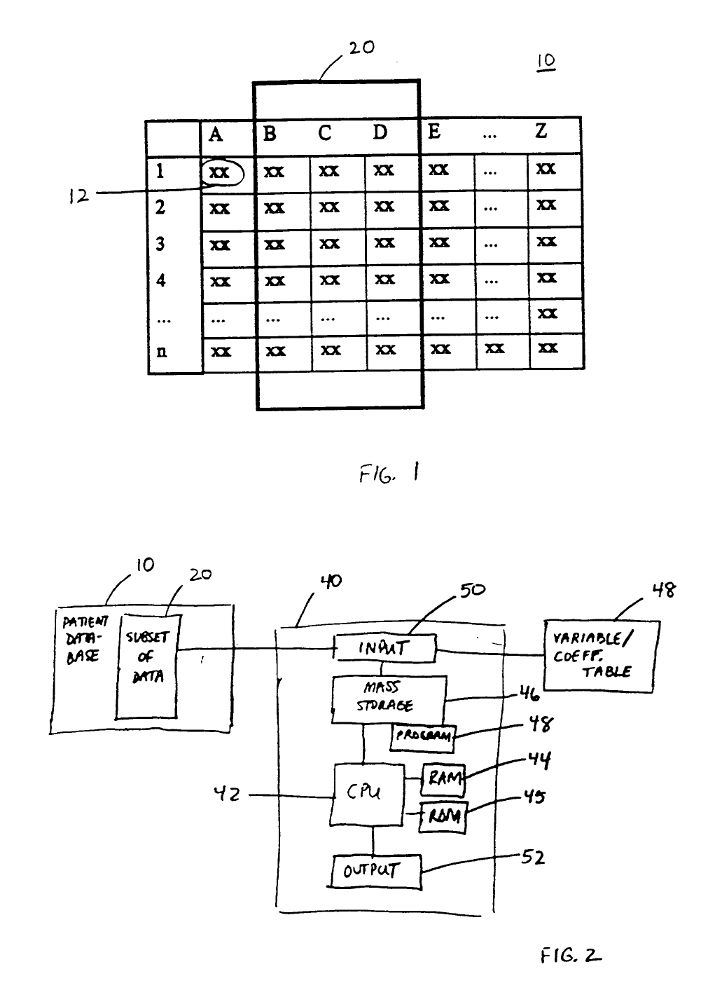

Referring to FIG. 2. apparatus in accordance with one embodiment of the present invention includes a computer 40, including a central processing unit or CPU 42. Computer 40 may be a general purpose programmable digital computer in the form of a main frame, mini or personal computer (“PC”).

A random access memory or RAM 44 is linked to the central processor through its internal database. Read-only memory (ROM) 45 is also preferably used and is preprogrammed with frequently used subroutines. The system further includes mass storage unit 46, which may incorporate one or more data storage devices such as magnetic disk drives, magnetic tape drives, optical or magneto-optical disk drives and/or solid state memory chips, such as flash memory. Each of these units may be of a conventional type, compatible with processor 42. Each of the elements of storage unit 46 has a physical location within which data can be stored and read.

The system further includes a program storage unit 48 which may incorporate a similar arrangement of one or more conventional mass storage devices, such as a disk drive or tape drive, adapted to read programming data representing a computer program stored on a storage medium. Program storage unit 48 may store both the program used by the computer 40 as well as the underlying data used by the program or the data may be separately stored on mass storage unit 46 or elsewhere where it can be retrieved by the computer 40. While program storage unit 48 and mass data storage unit 46 are symbolized as separate physical elements, these also can be integrated with one another in a common physical structure. For example, in a system having a conventional hard disk drive, the functions of program storage unit 48 and mass data storage unit 46 can be integrated in a single hard disk drive. Data defining an application program for actuating the system to perform the steps discussed below may be stored in program storage unit 48.

The system further includes local input devices 50 such as one or more conventional keyboards, serial or parallel ports and/or modem connections. Further, the system includes output devices 52, such as video displays and printers linked directly to processor 42.

The system may also be in the form of a network of computer terminals, in which case a network interface unit (not shown) would be connected to the processor. In such as case, the network interface would be connected via a dedicated LAN communications channel to a plurality of terminals disposed at distributed locations, such as throughout an office or the like. Each terminal would desirably include at least one data display device such as a video monitor or printer; at least one data entry device, such as a keyboard, mouse, or other data entry device; a local processor; and a local storage unit having therein a local program storage element. Each terminal may be a conventional personal computer, with a personal computer operating system stored therein.

The stored program is provided and is executable by the processor to perform regression analysis to create a probability equation and to execute the probability equation using data from the patient claims database to compute the probabilities of the patients being a high-cost patient. Thus, the stored program 48 includes the regression analysis software and, once the regression analysis has determined a model, program 48 also includes the model in the form of a probability equation including the preselected high relevance variables and their respective coefficients (i.e., the weighting in the form of a probability equation is a stored constant). The model is then used with the preselected subset 20 of claims data 10 that are relevant to the predictions for each patient. The resultant probabilities for each patient are computed by the computer are then provided to output 52 for use by the MCO or the like.

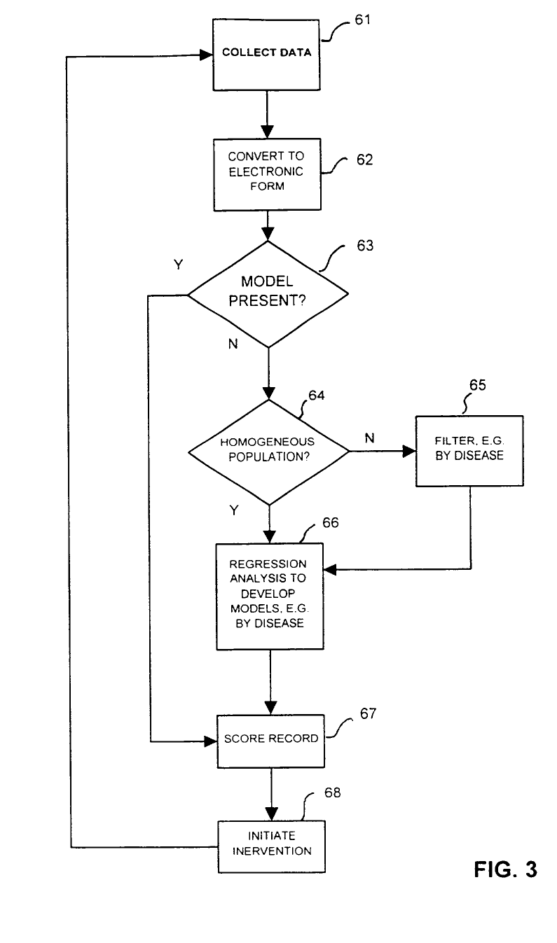

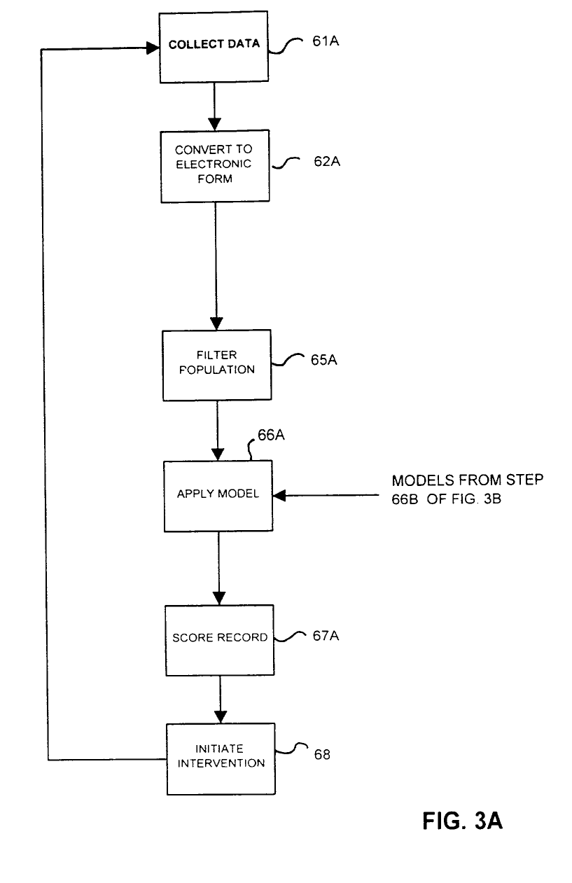

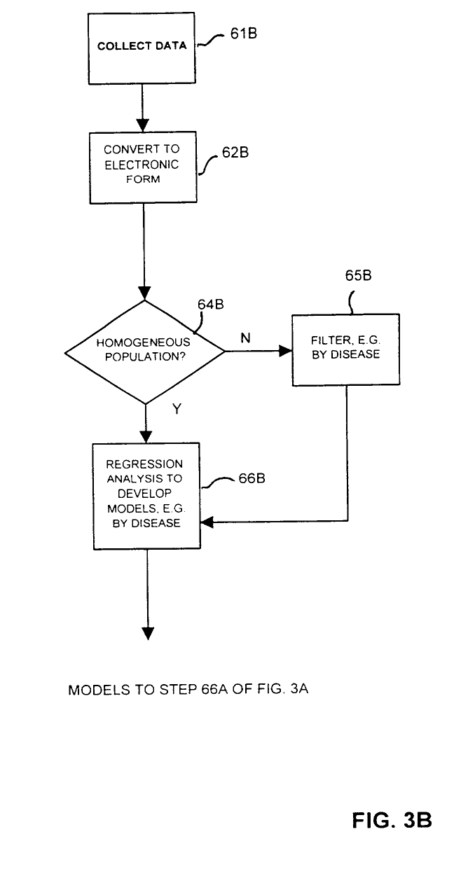

The operation of the computer of FIG. 2 is according to programs as illustrated in FIGS. 3, 3A and 3B. According to FIG. 3, a single program and a single computer are used to both create a model and to score patients on the basis of the model. In FIG. 3A, there is shown a flow chart for a program that only scores patients based on previously created models, which models may have been created on a separate computer or on the same computer at an earlier time. FIG. 3B is a flow chart of a program for only creating one or more models for subsequent use by the program of FIG. 3A. Referring to FIG. 3, one embodiment of the system of the present invention operates as follows: Patient data is collected which has various pieces of information about the patient (Step 61 of FIG. 3). Along with this data, data may be included on the cost of the medical services used by each patient in the previous period of time. This information is converted into electronic form (Step. 62 in FIG. 3) as patient records that are stored in the database 10. Next the CPU under the control of the program checks to see if a predictive model has been created previously (Step 63). If no model exists, then the program causes the CPU 42 to check to see if the patient population is relatively homogenous. It is very difficult to create accurate models with diverse populations of patients because they have very different motivations that control their behavior. However, it has been discovered that patients suffering from a particular disease or condition behave in very similar fashions as regards their medical treatment. Therefore, if the population is not otherwise homogeneous, it is filtered, for example on the basis of the disease or diagnosed condition of the patient to filter the population into more homogeneous sub-populations in step 65. As an example the population of patients can be segregated in the filter step 65 into asthma patients, diabetic patients, etc.

Once a homogeneous population or sub-population of patients is identified, then the regression analysis program operates on the various elements of patient data (A-Z in FIG. 1) to determine the predictive value of each variable (Step 66 in FIG. 3). Those variables or combinations of variables that are above a selected minimum ability to predict whether the patient will be a high user of medical services are selected (i.e., elements 20 in FIG. 1). This is accomplished by regressing the variables for the patient in a prior period of time against the utilization of medical service by that patient in the same period. The result is a model of the behavior of the patients as regards their utilization of the medical services. This will be in the form of a probability equation which includes the high relevance variables multiplied by their predictive power (weighting coefficients). The primary outcome variable of interest is the likelihood of an in patient admission for the person.

Once the model or probability equation has been formed, all of the patients in a particular sub-population have their records scored in step 67, i.e., they are given a score based on the individual values for their predictive variables. The higher the score, the more likely they are to be high-use patients.

High use of service patients typically use medical services more than is typical because they do not take their medication or otherwise do things that exacerbate their condition. As a result, when a patient is identified as being a high service user, the organization can intervene with them to make sure the disease management efforts are focused on that patient so the cost and effort of servicing that patient will be reduced. (Step 68). This process is repeated as new patients enter the system and data on them is collected. Periodically the regression analysis can be rerun to refine the model based on additional data, or to track changes in patient populations.

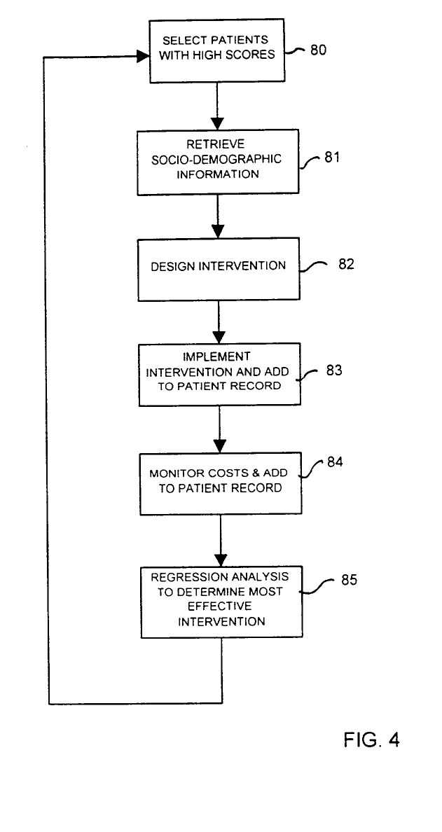

The scores which were assigned to patient records based on the model can be scaled to run from 0 to 100, with the higher number meaning a greater probability that the patient will become high-cost. Those patients with a score above a certain level, for example 90%, can be isolated for direct intervention by the MCO. The process by which this is accomplished is illustrated in FIG. 4. In particular, in step 80, those patients with a score above a predetermined level, for example 90 are selected out. Then, particular interventions can be attempted to try to get the patient to change his medical condition so that he no longer makes excessive use of the services.

By identifying a group of patients with a high probability of admission, scarce resources can be directed to those patients at the highest risk. Interventions designed to improve health and decrease the patient's risk can then be directed at these very high risk patients. Examples of such interventions include case management through an expert organization, such as the National Jewish Center for Allergic and Respiratory Diseases for an asthmatic who is identified by the model as being high risk. In addition, appropriate equipment might be given to the patient for self-monitoring to alert the patient very early that his medical condition is worsening. The patient's primary care physician would also be notified of the patient's high risk status, and would be closely monitored. These patients also would be invited to an educational seminar to learn more about managing their disease. Again, by directing these costly and labor-intensive resources at those most likely to benefit, medical costs will ultimately be reduced through improved outcomes at an acceptable cost.

As an option, a way of determining which type of intervention is most appropriate to them involves the addition socio/demographic information to the claims data on this group of patients (step 81). In particular, the patient's social security number or a zip code may be used to access commercial databases from which information about the patient can be retrieved. The patient's zip code, for example, is an indication of the average economic level in the area in which the patient lives and also gives information about whether the patient lives in a urban area or a rural area. This type of information is then append to the records of the patients having a very high score.

Based on this new collection of data, interventions may be designed for particular classes of the high-use patients (step 82). As an illustration an asthma sufferer living in an urban environment might have an intervention design which would suggest that the patient eliminate rugs and pets from their living environment, which would likely be a relatively closed apartment. They might also be counselled to make precautionary visits to a clinic within their zip code which specializes in monitoring asthma patients.

Once the intervention is designed, with or without socio/demographic information, it is then implemented with the various patients (step 83). Over the next time period of interest, the utilization of medical service by the patient is monitored (step 84) so that the patient record includes not only the intervention that was attempted, but the patient's use of services, and perhaps the cost for those services, in the period following the intervention. Based on this enhanced body of data, a regression analysis can be run as shown in step 85 to determine which type of intervention was most successful with a particular type of patient, where success is defined as lowering the use of medical service by the patient.

Instead of the procedure shown in FIG. 3 in which both model generation and scoring of patient records is accomplished in the same computer under a single program, it is more typical to create a model based on a subset of data prior to engaging in the process of scoring patient information. FIG. 3B represents a flow chart for a program for the development of a model or models. In this arrangement, data is collected and converted into electronic form (steps 61B and 62B). This could represent, for example, about 10-20% of the available patient information. Then a check is made at step 64B to see if the population is relatively homogenous. If it is not, one way of assuring that it is relatively homogenous, or at least more so, is by segregating the patient population by the disease which has been diagnosed, for example, asthma or diabetes (step 65B). Then, for each group of patients, a regression analysis is used in step 66B to develop a model for that particular disease. Once it has been determined that the model is relatively accurate, for example, by tracking the prediction made by the model versus actual patient service use for a particular period of time, it can be stored and implemented in the process of FIG. 3A.

This type of modeling and refinement of models requires a substantial amount of computing power and may preferably be performed on a mainframe computer or a mini-computer. The result of this analysis will be one or more probability equations based on a particular disease diagnosis.

Once a model or models have been developed, the probability equation representing the model can then be loaded onto another computer, for example a personal computer located at a position which is convenient for the receipt of patient information. Then, as patients provide information, or in a large batch collected over a period of time, the patient information is converted into electronic form as shown in FIG. 3A (step 62A). The program then sorts this data, for example, according to the disease indicated by particular patient records (step 65A). Then the program applies the probability equation to patient records indicating the particular disease for which the model was created (step 66A). The result is a patient score (step 67A) which ranges from 0 to 100 and indicates the probability that the patient will be high-cost. Those patients with a high score then are intervened with in step 68 according to the process shown in FIG. 4.

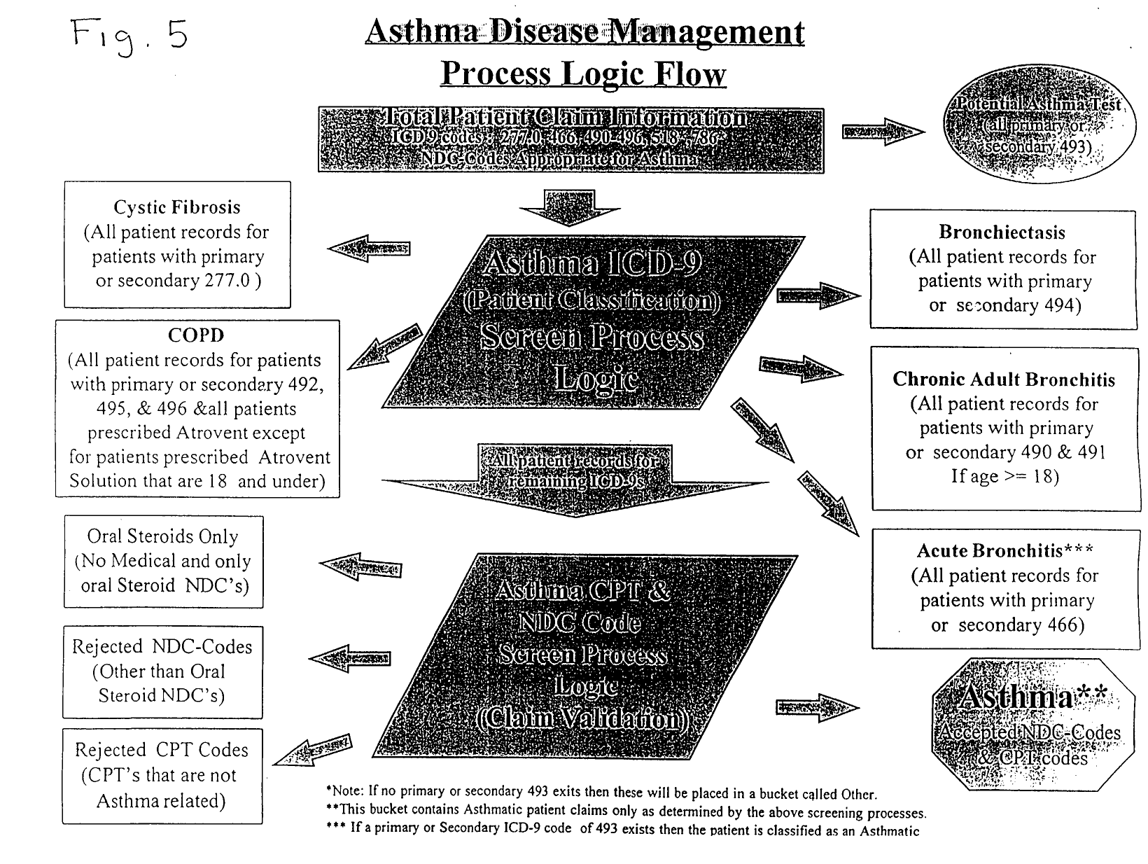

One exemplary use of the present invention is in determining the likelihood that an asthmatic patient will become a high use patient to the MCO. In this application, many different claims variables and encounter data (e.g., an ER visit) are available for potential use in the model. Such potential variables may include, among others, the patient's age at the end of an index year (AGE); the patient's sex (SEX); the number of hospital in-patient days for respiratory-related admissions involving ICU care at any time during the admission (ICUDAY); the number of hospital in-patient days for respiratory related admissions not involving ICU care at any time during the admission (SPDAY); the number of hospital in-patient days for non-respiratory related admissions (OTHRDAY); whether the patient has had one respiratory related ER visit in the index year (ERRESPC1); whether the patient has two or more respiratory related ER visits in the index year (ERRESPC2); the number of the patient's non-respiratory related ER visits (ER_OTHR); the number of respiratory related office visits of the patient (OV_RESP); the number of non-respiratory related office visits (OV_OTHR); the number of prescription drug claims (RXCNT); the presence or absence of an allergy-related diagnosis (CMALERG2); the presence or absence of a respiratory infection diagnosis (CMINFEC2); the presence or absence of another respiratory related (comorbid) diagnosis (CNIRSPIR2); the presence or absence of hypertrophied nasal turbinate diagnosis (CMNAST2); and the presence or absence of respiratory complication diagnosis (CONDLIC). Of course, other claims data and encounter information can also be stored and used in the patient database. It should be appreciated that while terms such as “asthmatic,” “allergies” and “respiratory complications” have been used as part of the claims data, these variables may not be found in all claims databases and may represent descriptive summaries of a patient's claim history, and variable values can be assigned based on specific logical assumptions used to classify a patient as “asthmatic” are found in the chart of FIG. 5.

The probability equation utilizes high relevance claims variables comprising a preselected subset of the total possible claims variables. Such high relevance variables are selected by the process of logistic regression analysis modeling. In the case of asthmatic patients, as a result of the statistical regression analysis, the high relevance claims variables preferably comprise AGE, SPDAY, OTHRDAY, OV_RES, RXCNT, CMALERG2, CMNAST2, COMPLIC2, ERRESPC1, and ERRESPC2. Each of these selected variables is then multiplied by a weighing coefficient also determined by the logistic regression model, to impart the proper weight or significance of each variable in the overall probability equation.

Below in Table I is listed one set of the coefficients for each high relevance variable used in the probability equation for determining patients likely to become high service use asthmatic patients:

TABLE 1

| Variable | Coefficient |
|---|---|
| AGE | 0.0126448 |
| SPDAY | 0.0953723 |
| OTHRDAY | 0.1180409 |
| OV RESP | 0.0856478 |
| RXCNT | 0.0763379 |
| CMALERG2 | 0.4367416 |
| CMAST2 | −1.977074 |
| COMPLIC2 | −0.2768944 |
| ERRESPCI | 0.840951 |
| ERRESPC2 | 1.078454 |
| Constant | −2.939101 |

From Table 1, it can be seen, for example, that in addition to the high relative significance of ER visits (ERRESPC1 and ERRESPC2) in predicting future high use patients, surprisingly, the relative significance of allergies (CMALERG2) is also quite high. Also, it is unexpected that there is a negative correlation between complications in the past year (CONTLIC2) and the probability of becoming a high use patient.

For example, consider a 55-year-old patient who had 3 respiratory-related hospital days. This patient had no admissions involving ICU care, and all of the admissions were for respiratory-related problems. The patient had 2 office visits and 1 ER visit for respiratory-related problems as well as 5 prescription drug claims. There were no allergies, nasal turbinate hypertrophy, or complications. Using the modeling coefficients of Table 1, the probability of this patient becoming a high use of service asthmatic is calculated as follows in Table 2:

TABLE 2
Sample Probability Calculation

| Variable | Value | Coefficient | Product |
|---|---|---|---|
| AGE | 55 | 0.0126448 | 0.695464 |
| SPDAY | 3 | 0.0953723 | 0.286117 |
| OTHRDAY | 0 | 0.1180409 | 0 |
| OV-RESP | 2 | 0.0856478 | 0.171296 |
| RXCNT | 5 | 0.0763379 | 0.381690 |
| CMALERG2 | 0 | 0.4367416 | 0 |
| CNWAST2 | 0 | 1.977074 | 0 |
| CONTLIC2 | 0 | −0.3768944 | 0 |
| ERRESPC2 | 1 | 0.840951 | 0.840951 |
| ERRESPC2 | 0 | 1.078454 | 0 |
| Constant | | −2.939101 | −2.939101 |
| | | Logit | −0.563584 |
| | | Probability | 0.362719 |

Thus, a patient with these characteristics would have a 36% probability of being a high use asthma patient in the following year, i.e., a score of 36.

Once the high use patients are determined, a threshold value can be set by the MCO, such as 50%, and the MCO can then target such high use patients falling above the threshold with preemptive intervention strategies to attempt to change the likely course of the disease, and lower the likelihood that the patient will become a high user of the medical services. For high-use asthmatic patients, such preemptive intervention strategies broadly include, for example, patient education, patient support services and information gathering. Examples of patient education include providing disease-related written materials, videos and counseling. Support services may include providing the patient with devices to measure lung capacity, and evaluation or monitoring programs to determine the patient's current health status. Additional information gathering may include conducting surveys, confirming certain claims elements and obtaining more detailed clinical information from the physician.

The predictive model used by the present invention is preferably a statistical model created using well-accepted logistic regression analysis tools and methods. The statistical modeling can be performed using a personal computer (or mainframe computer) and readily available commercial statistical software packages, such as SAS offered by SAS Institute, Inc. of Cary, N.C., or STATA offered by Stata Corporation of College Station, Tex. Various other commercial statistical software packages for performing regression analysis are readily available, such as SPSS offered by SPSS Inc. of Chicago, Ill. For further information on regression techniques useful in the practice of the present invention, see Michael J. A. Verry and Gordon Linoff, Data Mining Techniques, Wyley Computer Publishing (1997), which is incorporated herein by reference.

In the first step of regression analysis (step 66B of FIG. 3B), a regression model is built using all of the potentially predictive variables which have an effect on the patient's future likelihood of developing a pattern of high use of the services, particularly high-cost occurrences or episodes. Such variables are all claims variables (and possibly some demographic variables) suspected of having some positive or negative effect on the outcome variable, such as age, number of hospital admissions, number of prescriptions filled, occurrences of complications, ER visits, etc. The outcome variable, a dependent variable, is the patient's frequency of disease-related demands for service in the target year.

Alternatively, in lieu of determining whether a patient will be a high service use patient overall, the present invention can also be used to predict other behavior characteristics of the patient, such as the probability the patient will suffer a high-cost medical episode or event, such as a visit to the ER or a hospital stay. In such a case, the outcome variable to be examined is the specific event or events to be predicted.

The use of multivariate logistic regression analysis is itself well-known to those in the statistics field and therefore will not be described herein in further detail. As a general matter, logistic regression analysis is a powerful and well-known forecasting technique which examines not only historical data of the variable one wants to predict (e.g., high-use asthmatic patients), but also the data of other variables that may assist in making that prediction (e.g., length of hospital stays, number of prescriptions, etc.). In the present invention, the variables used in modeling come from medical and pharmacy claims data, with the ones selected, both individually and in combination, being those with the highest impact on the patient outcome.

After evaluating the results of the initial regression model with all probable variables, the least predictive variable of all of the potential variables is eliminated and the regression analysis is then repeated on the remaining variables. An iterative process of eliminating the next least predictive variable using the regression analysis is continued and repeated until all of the remaining variables are considered to be sufficiently highly significant based on standard statistical measures. The measure of high significance for the variables can be varied based on the sensitivity chosen in the regression model. Once the final subset of high relevance variables is selected, further testing of the model is done by adding back previously removed variables and testing their individual effect on the model. If a variable was mistakenly eliminated, it can be added back to the model.

Once the model is established using data from a given period of time, it is preferably tested by applying the model to a second database with the model predictions being compared to the actual frequency of patient disease-related service use in the target year. In addition, the model's accuracy and reliability are preferably assessed by examining two important performance characteristics; namely, calibration and discrimination. Calibration determines whether the probability generated by the model accurately predicts the true, high service use population. This is measured by the known technique of “goodness-of-fit” testing. Generally speaking, goodness-of-fit testing looks to see if there is sufficient evidence based on new data to conclude that the model developed using prior data is still accurate. Calibration is considered acceptable if the goodness-of-fit statistic is greater than 0.05.

To evaluate discrimination, a receiving operation characteristic (ROC) curve is used to compare each high service use patient to all low service use patients to determine the percentage of pairings in which the high service use patient has a higher calculated probability. Areas above 70% are considered acceptable, above 80% are considered goods, and above 90% excellent, although this level is rarely attained.

In the case of the regression model discussed above for predicting overall high service use asthmatic patients, two separate patient databases were used in determining the regression model. The first database included claims information from a given year (year 1) as potential independent variables and year 2 asthma-related use of services (the dependent variable). The second database used year 2 claims data and year 3 utilization information. The first year in each database is deemed the index year and the second is deemed the target year.

To create a reliable predictive model for high-use asthmatic patients, several restrictive criteria are preferably used. For instance, patients must have submitted claims in both the index and the target year to ensure that a patient no longer enrolled in the plan would not be considered low use. Patients must also be classified as “asthmatic” in the index year, and must be classified as “asthmatic,” “general symptoms” or “other” in the target year. This is preferably accomplished using a set of logical assumptions developed to allow accuracy in classification of the patient as shown in FIG. 4.

The algorithms ensure that patients who were not classified as “asthmatic” in the target year, because they had few medical encounters, would be correctly identified as low use patients, and patients who were later determined to have COPD (chronic obstructive pulmonary disease) or other conditions would not be included in the analysis based on the assumption that asthmatic-directed disease management will have little effect on these patients.

Finally, testing of the regression model should use sample populations large enough for reliable analyses. The models developed can be further stratified based on demographic information, such as age, ethnicity, sex, etc. to increase the accuracy and reliability of the model. It should also be noted that depending on how certain choices are made in the regression modeling, the resultant model can differ, thus arriving at different coefficients and even different high relevance claims variables. For this reason, the resultant model can and likely would be slightly different, depending on the choices made during the modeling process.

Although the invention herein has been described with reference to particular preferred embodiments, it is to be understood that such embodiments are merely illustrative of the principles and applications of the present invention. It is therefore to be understood that numerous modifications may be made to the illustrative embodiments and that other arrangements may be devised without departing from the spirit and scope of the present invention.

We claim:

1. A method of identifying patients likely to have future high use of medical services, comprising the steps of:
collecting patient claims data in electronic form on a population of patients as records for each patient, each patient record including at least claim elements identifying the patient, a disease or condition and prior utilization of medical services;
creating a model for predicting which patients will require a disproportionately high use of medical services based on the patient claims data by performing regression analysis on each of the claims elements to select one or more high relevance claims elements and their relative power or weight in predicting high use, said model being expressed as a probability equation in the form of the sum of each of the high relevance claims variables multiplied by its weighing coefficient; and
applying the claims data for at least one of the patient records to the probability equation to assign a score to the patient record based the result of the probability equation, said score being a prediction of the relative likelihood that the patient will use a disproportionately high amount of medical services.

2. The method according to claim 1, further including the step of intervening with patients having a score above a predetermined threshold.

3. The method according to claim 2 wherein the regression analysis step is based on selecting claims variables which have an effect on an outcome variable, the outcome variable corresponding to a high-use criterion during a targeted time frame, the regression analysis step further including the steps of:
(a) selecting an initial set of potentially predictive claims variables which potentially have an effect on the outcome variable;
(b) performing regression analysis on the potentially predictive claims variables;
(c) eliminating the least predictive variables based on the results of the regression analysis;
(d) repeating steps (b) and (c) until each of the remaining claims variables have a significance value greater than a predetermined threshold significance value; and
(e) identifying the remaining claims variables as high relevance claims variables.

4. The method according to claim 2, where the patients are segregated into sub-populations based on a determination of the patient's disease or condition using logical assumptions.

5. The method according to claim 4 wherein the patients in a sub-population potentially have asthma and the predetermined high relevance claims variables include at least one of the group consisting of the age of the patient, the number of hospital inpatient stays for respiratory-related admissions involving intensive care, the number of hospital inpatient days for non-respiratory-related admissions, the number of respiratory-related office visits, the number of prescription drug claims, a variable reflecting allergy-related diagnosis, a variable reflecting hypertrophied nasal turbinate diagnosis, a variable reflecting respiratory complication diagnosis, a variable reflecting an emergency room visit within a predetermined time frame and a variable reflecting multiple emergency room visits within a predetermined time frame.

6. The method according to claim 1 wherein the high relevance claims variables include the presence or absence of certain events as a measure of the patient's risk of high use of medical services.

7. The method according to claim 1 further including the step of testing the model by applying the model to a second set of patient claims data with the model predictions being compared to the actual use of services in a predetermined time frame.

8. The method according to claim 2 further including the step of generating an intervention designed to reduce the use of services required by the patient having a score indicating an above average probability that the patient will incur high use.

9. The method according to claim 4 wherein the intervention is one of a written message, a verbal message and a video message sent to a party responsible for the patient.

10. The method according to claim 1 further including the steps of:
segmenting the patient records into predetermined sub-populations based on the patient claims data prior to the step of intervening; and
creating separate interventions for each sub-population.

11. The method according to claim 1 wherein the patients are members of a managed care organization which carries out the method.

12. A method of identifying patients who are likely to have future high utilization of medical services, comprising the steps of:
collecting patient claims data in electronic form on a population of patients as records for each patient, each patient record including at least an identification of the patient and claims data associated with a predetermined group of high relevance claims variables;
applying a probability equation to the claims data for at least one of the patient records based on the sum of each of the predetermined high relevance claims variables multiplied by a predetermined weighing coefficient;
assigning a score to the patient record based the result of the probability equation, said score being a prediction of the relative likelihood that the patient will incur high use of medical services; and
intervening with the patient having a score indicating an above average probability that the patient will incur high use of medical services.

13. The method according to claim 12 wherein the predetermined group of high claims variables is selected by performing regression analysis on the claims variables to select high relevance claims variables and calculating the predetermined weighing coefficients for each of the high relevance claims variables.

14. The method according to claim 12 wherein the patients are members of a managed care organization which carries out the method.

15. The method according to claim 13 wherein the regression analysis is one of logistic regression analysis and linear regression analysis.

16. The method according to claim 12 wherein the predetermined high relevance claims variables include the presence or absence of certain events as a measure of the patient's risk of incurring high use of medical services.

17. The method according to claim 12 further including the step of generating an intervention designed to reduce the use of medical services incurred by the patient having a score indicating an above average probability that the patient will incur high use.

18. The method according to claim 16 wherein the intervention is one of a written message, a verbal message and a video message sent to a party responsible for the patient.

19. The method according to claim 12 further including the steps of:
segmenting the patient records into predetermined sub-populations based on the patient claims data prior to the step of intervening; and
creating separate interventions for each sub-population.

20. Apparatus for identifying patients who are likely to have high utilization of medical services, comprising:
at least one data processing terminal through which patient claims data is collected on patients in electronic form, said terminal collecting the data in the form of records for each patient, each patient record including variable elements of data providing at least an identification of the patient and the utilization of medical services by the patient;
a database in the form of an organized memory in which the patient records are stored;
a predictive computing system including a processor, a processor memory and a device for accessing patient records in said database, said processor memory storing a regression analysis program which operates in said processor on the various elements of data in the patient record in regard to selecting a group of one or more high relevance claim variables to create a model for predicting which patients will incur high medical service utilization, said model being stored in the processor memory.

21. Apparatus for identifying patients who are likely to have high use of medical services, comprising:
at least one data processing terminal through which patient claims data is collected on patients in electronic form, said terminal collecting the data in the form of records for each patient, each patient record including variable elements of data providing at least an identification of the patient and the utilization by the patient of medical services;
a database in the form of an organized memory in which the patient records are stored;
a predictive computing system including a processor, a processor memory and a device for accessing patient records in said database;
said program memory storing a model as a probability equation predicting which patients will incur high utilization of medical services, said processor further assigning a score to each patient record based on the model, the score being a prediction of the relative likelihood that the patient will incur high use of medical services; and
an output device for indicating the score.

22. The apparatus of claim 21 wherein said processor memory stores an intervention, said intervention being triggered by a patient record being assigned a particular score.

23. The apparatus of claim 22 in which the intervention is a message, and the processor causes the output device to generate the message and send it at a predetermined time for patient records that have triggered an intervention.

24. The apparatus of claim 21 wherein the processor memory further includes a program for segmenting patient records into clusters based on population data in the patient record.
